(19) United States
(12) Patent Application Publication
(10) Pub. No.: US 2017/0243282 A1
(43) Pub. Date: Aug. 24, 2017

(54) AN IMPROVED DESIGN CLOTHING DISTRIBUTION SYSTEM AND PROCESS

(71) Applicant: Dezignerex Group Pty Ltd, Pyrmont, New South Wales (AU)

(72) Inventors: Costa KOULIS, Pyrmont, New South Wales (AU); Kirsten KORE, Pyrmont, New South Wales (AU)

(73) Assignee: Dezignerex Group Pty Ltd, Pyrmont, New South Wales (AU)

(21) Appl. No.: 15/513,111

(22) PCT Filed: Sep. 2, 2015
(86) PCT No.: PCT/AU2015/000534

§ 371 Date: Mar. 21, 2017

(30) Foreign Application Priority Data
Sep. 22, 2014 (AU) 2014903773
Feb. 27, 2015 (AU) 2015900702
Jun. 30, 2015 (AU) 2015902537

(51) Int. Cl. G06Q 30/06; G06Q 30/08

(52) U.S. Cl. CPC G06Q 30/0645; G06Q 30/08

(57) ABSTRACT

A system for use in the rental of designer clothing from a lender to a borrower, wherein the system comprises the steps of recording a borrower profile associated with the borrower and a lender profile associated with the lender, each lender's profile include a list of designer ability information. At least one borrower places at least one bid to rent at least one piece of designer clothing from the lender profile for a specified available time that matches the respective time availability information. Ata predetermined closing time, the system closes bids from borrowers and awards the rental of the piece of designer clothing to the borrower who placed the highest bid at the closing time. The borrower facilitates a payment to the lender through the use of the system; and the lender delivers the designer clothing to the borrower.

### TECHNICAL FIELD

The present invention relates to an improved designer clothing distribution system or process for supplying rental designer clothing to customers and clients in an efficient and cost effective manner.

### BACKGROUND

There has been strong demand in the marketplace for designer clothing. Typically, designer clothing is relatively expensive for regular consumers and additionally this designer clothing may only be wanted to be worn a very limited amount of times by the consumer or purchaser.

Renting designer clothing allows customers to wear designer label clothing at upcoming special or gala events, potentially for a fraction of the cost of buying and having to outlay the full purchase price of the particular piece of designer clothing. It also gives consumers the advantage of being able to quickly and easily vary their wardrobe of clothing to access sophisticated designer clothing.

Furthermore, with the rapid growth of social media, which displays the outfit a customer has worn at an event, the desire to limit the amount of times the same outfit is worn and seen on social media, has made designer clothes customers more sensitive to the number of times they are seen wearing the same outfit.

The benefits of designer wear rental have also been mentioned in such iconic films as Sex and The City™, as well as in television shows such as Oprah™.

The traditional designer wear rental business model, has involved the requirement to purchase designer wear as inventory, then on-rent that inventory to the end user. The biggest restraint to this traditional business model is the ongoing need for capital on the business to purchase a never-ending requirement for designer wear inventory. The range offered to the consumer under this model is also limited by the inventory buying ability of the business.

The traditional business model then evolved to “sharing business models” that typically required or focused on physical intervention by the participants to meet up, or to physically drop off, send or deliver designer clothing, to and from, pre-determined locations or a central geographic location or other technical lending or borrowing restrictions (in addition to any transport to the end borrower). This type of business model is constrained because of logistic issues relating to the excess physical intervention of items of designer clothing, which created, amongst things, inefficiencies by double handling of the same item.

Existing peer to peer ‘sharing business models’ do not create an efficient peer to peer designer clothes sharing marketplace. Furthermore, while some early ‘sharing business models’ may have provided an option for management of a ‘lenders’ item of clothing, this was an inefficient ‘triple-handling’ model if a lender interacted with another lender to manage their item of clothing.

Previously, in these sharing business models when a lender's role was viewed in isolation, they each became a traditional rental business model lender upon joining, and as described above, a constraint is the purchasing budget for items of clothing. The present disclosure, may enable designer clothes lenders to connect with other lenders or designer clothes owners that may not be aware of peer to peer sharing or may not have time for peer to peer sharing or may select another lender to manage their item of clothing.

Previously, there has been no way for designer clothing customers to compare listings from various designer clothing rental providers. Additionally, designer clothing rental businesses have been unable (whether comprising sharing based business models, or inventory based business models) to aggregate their designer clothing rental listings into one online web portal. Other online web portals that aggregate results include Wotif™, and Expedia™. However Wotif™ is strictly limited to aggregating results for hotel bookings and Expedia™ aggregates results for hotel and flight bookings. Neither of the aforementioned websites are capable of aggregating results and solving the problems inherent specifically to the rental of designer clothing, and are not suitable for this purpose.

Previously, there has been no way for designer clothing to be rented to consumers with a method that enabled borrowers, which may also be known as renters and lenders, which may also be known as rental providers, to compare listings from various designer clothing rental providers, in one single designer clothing rental marketplace.

Furthermore, previously there has not been an online marketplace for the rental of designer clothing to facilitate efficient direct transactions between lenders and borrowers, and for designer clothing owners and rental businesses to add their own direct listings into that one designer clothing rental market place.

In addition, there has never been a marketplace for designer clothing rentals, let alone one with aggregated listings from both designer clothing rental businesses, and consumers with direct listings of their own,

Furthermore, previously there has never been a marketplace for designer clothing rentals, with aggregated listings from both designer clothing rental businesses, and consumers with direct listings of their own, with an ability to offer those listings by way of auction.

Previously, there has been no way for designer clothing to be rented peer to peer, in a designer clothes peer to peer sharing marketplace which may electronically verify the identification of a renter and/or a lender.

Previously, there has been no way for designer clothing to be rented peer to peer, in a designer clothes peer to peer sharing marketplace which may integrate data with another peer to peer collaborative marketplace.

Previously, there has been no way for designer clothing to be rented peer to peer, in a designer clothes peer to peer sharing marketplace that electronically verified the identification of a renter and/or a lender.

Previously, there has been no way for designer clothing to be rented peer to peer, in a designer clothes peer to peer sharing marketplace that electronically integrated data with social media data. While some existing systems allow for a login or sign-in association of user data these systems do not import any useful historical data, transactional data or reputation data.

Previously, there has been no way for designer clothing to be rented peer to peer, in a designer clothes peer to peer sharing marketplace that integrates data of Renter and/or Lenders and/or designer clothers with third party insurance providers.

Previously, there has been no way for designer clothing to be rented peer to peer, in a designer clothes peer to peer sharing marketplace that is integrated (manually or via data integration) with a drone delivery system.

Previously, there has been no way for designer clothing to be rented peer to peer, in a designer clothes peer to peer sharing marketplace that includes an affiliate system, through affiliate software, or an affiliate network, for referrals of peer to peer renters and/or peer to peer lenders into a designer clothes peer to peer sharing marketplace.

Previously, there has been no way for designer clothing to be rented peer to peer, in a designer clothes peer to peer sharing marketplace that records, compiles and distributes peer to peer designer clothes sharing data, and then distribute this data to the users of the system or to third parties.

Previously, there has been no way for designer clothing to be rented peer to peer, in a designer clothes peer to peer sharing marketplace that electronically verifies the credit worthiness or credit history or review rating of a user with a third party database or any other type of third party electronic means of verifying. There has never been an electronic means to check a credit or review rating in a designer clothes sharing marketplace as described herein.

Furthermore, there has never been a marketplace for designer clothing rentals, with combined aggregated listings from designer clothing rental businesses and consumers, with direct listings of their own, with an ability to offer these listings efficiently and direct to each other without the use of drop-off or pickup points or other physical invention and constraints created by meetup points or a central location (in addition to transportation).

Furthermore, there has never been a marketplace for design clothing rentals, with aggregated listings from consumers and rental businesses, with direct listings of their own, with an ability to offer these listings efficiently and direct to other people without the use of drop-off or pickup points or other physical intervention and constraints created by a central location (in addition to transportation).

Previously, there has been no efficient and cost effective way for consumers to temporarily gain access to high level designer clothing in the manner described herein. We note that there have been attempts in the past to provide systems or processes for renting and distributing clothing however these systems are very limited in application and generally not suitable or as efficient as described herein, for the specific requirements of designer clothing rental distribution.

U.S. Pat. No. 6,885,998 describes a basic system for the rental and distribution of sporting gear to customers. This system is limited to sporting gear applications and is tailored to deliver bulk orders of sporting goods which is useful for delivering sporting goods to sporting teams but not appropriate for designer clothing.

U.S. Pat. No. 5,088,586 describes a vending machine for distribution of rental items including clothing. However, the customer is required to visit the vending machine location to pick-up the items and then must again visit the vending machine location to return the items after the rental is completed. This type of system is generally not efficient for customers and consumers as it is generally inconvenient. Additionally, people who are likely to rent designer clothes are unlikely to have the necessary time to visit a vending machine at a distant location.

Another system is proposed by a business operating a website called Good Karma Clothing™. The system is detailed on a webpage at http://mashable.com/2012/02/24/good-kaima-clothing/. This system allows for customers to pay a monthly fee to subscribe as a member. Members are entitled to receive shipments of recycled baby clothes and once their child has outgrown the clothes, the clothes are returned and recycled again. This system is not appropriate for designer clothes as it doesn't consider that demand increases for designer clothing in accordance with the timing of special events. Also this system is tailored for use with baby clothing and leverages the system off the needs of mothers with small children or babies.

Any discussion of the prior art throughout the specification should in no way be considered as an admission that such prior art is widely known or forms part of common general knowledge in the field.

### SUMMARY

### Problems to be Solved

It is an aim of the present invention to provide a system or process to alleviate or reduce physical intervention and/or to improve rental or distribution processes in relation to renting of items or pieces of designer clothing. It is a further aim of the present invention to use a system that provides for price fluctuation of rented items as an option rather than subscription or fixed cost based business models of renting clothing, where applicable.

It may be an aim of the present invention to provide all the tools, systems and processes, that are necessary to create an efficient peer to peer designer clothes sharing marketplace.

It is an object of the present invention to overcome or ameliorate at least one of the disadvantages of the prior art, or to provide a useful alternative.

### Means for Solving the Problem

A first aspect of the present invention may relate to a system or process for use in the rental of designer clothing from a lender to a borrower, wherein the system comprises the following steps:
a. recording a borrower profile associated with the borrower and a lender profile associated with the lender;
b. each lender's profile include a list of designer clothing available to be rented and a respective time availability information;
c. at least one borrower places at least one bid to rent at least one piece of designer clothing from the lender profile for a specified available time that matches the respective time availability information;
d. at a predetermined closing time, the system closes bids from borrowers and awards the rental of the piece of designer clothing to the borrower who placed the highest bid at the closing time;
e. the borrower facilitates a payment to the lender through the use of the system; and
f. the lender delivers the designer clothing to the borrower.

Preferably the system or process may comprise an additional step wherein the borrower pays a security deposit or authority to the value of piece of designer clothing.

The preferred process or system may include the borrower profile or lender profile further including additional review information about the respective borrower or lender independently submitted by third parties.

The preferred system or process as described, wherein the first payment additionally includes: insurance costs, cleaning costs and delivery costs.

The preferred system or process as described, wherein the system is adapted to allow the borrower and lender to make comments about the performance of the opposed party which are recorded by the system in the respective lender or borrower profile.

Preferably, the borrower makes a first payment to the system and then the system makes a second payment to the lender; or the system facilitates a secure direct transaction for payment.

Preferably the lender may set a fixed price for winning bids; or sets a minimum starting value for the bids.

The preferred system may deliver at least one piece of designer clothing to a predetermined address of the borrower without the need for a drop-off point

The preferred system may also produce and electronically deliver a customised 3D printing file to the Lender or Borrower. Further, the preferred 3D (three dimensional) printing file including electronic printer instructions to print a three dimensional package or label.

In a second preferred aspect of the present invention, a device is provided, wherein said device is for transacting the rental of items of designer clothing, wherein the device aggregates the lists of said items from multiple lenders and then displays said lists on a web portal interface for borrowers to interact with and browse; and wherein the borrower wishes to rent said item, the device enables a transaction.

Preferably, the transaction includes an online auction. Preferably, the aggregator uses a process to conduct the transaction and wherein the process includes the following steps: recording a borrower profile associated with the borrower and a lender profile associated with the lender; each lender's profile include a list of designer clothing available to be rented; and a respective time availability information; the borrower places at least one bid to rent at least one piece of designer clothing from the lender profile for a specified available time that matches the respective time availability information; at a predetermined closing time, the system closes bids from borrowers and awards the rental of the piece of designer clothing to the borrower who placed the highest bid at the closing time; the borrower makes a first payment to the system and then the system makes a second payment to the lender; and the lender delivers the designer clothing to the borrower.

Preferably the process may comprise an additional step wherein the borrower pays a security deposit or authority to the value of piece of designer clothing.

The preferred process may include the borrower profile or lender profile further including additional review information about the respective borrower or lender independently submitted by third parties.

The preferred process as described, wherein the first payment or rental payment additionally includes: insurance costs, cleaning costs and delivery costs.

The preferred process as described, wherein the system is adapted to allow the borrower and lender to make comments about the performance of the opposed party which are recorded by the system in the respective lender or borrower profile.

Preferably, the borrower makes a first payment to the system and then the system makes a second payment to the lender.

Preferably the lender may set a fixed price for bids; or sets a minimum starting value for the bids.

The preferred process may deliver at least of one piece of designer clothing to a predetermined address of the borrower without the need for a drop-off, delivery or meetup point.

The preferred process may alleviate at least one of the inventory purchasing constraints of a rental business lender, the ‘sharing economy’ time or effort management constraints of an individual lender, by enabling a lender or lenders to assign an item of designer clothing, to be managed by a rental business lender or any other lender (business or individual) that has made themselves available to manage the item of designer clothing of the lender or lenders.

A process for integrating a data set of an item of designer clothing, the process comprising; entering at least one data set associated with the item of designer clothing into the system; the system may be in communication with a designer clothing sharing portal; the designer clothing sharing portal may be configured to access at least one data set related to the item of designer clothing; and wherein the at least one data set of the item of designer clothing and the at least one data set of the similar item of designer clothing are used to calculate either a sharing economy value, or assign a data set from the designer clothing sharing portal to the item of designer clothing.

Preferably, the sharing economy value may be automatically determined or calculated and then automatically displayed to at least one of a designer clothing retailer or a designer clothing sharer.

Preferably, listing of the item of designer clothing may be managed by a network of designer clothing lenders such that when the item of designer clothing is managed a notification may be sent to the lender who may be at least one of the designer clothing retailer or the designer clothing sharer.

In the context of the present invention, the words “comprise”, “comprising” and the like are to be construed in their inclusive, as opposed to their exclusive, sense, that is in the sense of “including, but not limited to”.

The invention is to be interpreted with reference to at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIGS. 1a and 1b depict a flowchart of a system or process as per a first preferred embodiment of the present invention. Please note that the flowchart of FIG. 1a is continued in FIG. 1b; and

FIG. 2 depicts a system architecture shown in a diagrammatic format.

FIG. 3 depicts a flowchart of an embodiment of a designer clothing sharing system.

FIG. 4 depicts a flowchart of another embodiment of a designer clothing sharing system.

### DESCRIPTION OF THE INVENTION

Preferred embodiments of the invention will now be described with reference to the accompanying drawings and non-limiting examples.

The first preferred embodiment of the present invention includes a collaborative consumption business model (also known as Peer to Peer business model), is a business model based on sharing, or renting designer clothing and/or designer clothing accessories, directly between the users of the systems. Typically, the actual owner of the designer clothing in this specification is called a “lender” and their specific role is to lend designer clothing to other parties in exchange for monetary consideration. The definition of lender may include the owner or controller of an item of designer clothing. The definition of lender may include the actual designer of the designer clothing wherein they have a surplus of stock and willing to lease the said designer clothing to others.

In this specification, the definition of user also includes a party called a borrower. A borrower is the party or person who is willing or engages in the borrowing or leasing act for the delivery of designer clothing on a temporary arrangement from the lender in exchange for monetary consideration.

Preferably, the items of designer clothing are physically sent direct to the participants or users of this system without any requirement for drop-off points, pickup points or any physical invention by a central location (in addition to the online environment and transportation).

The users monetise their own inventory efficiently and directly between each other.

It is also referred as the ‘sharing economy’ and it is experiencing phenomenal growth. Generally, the success of collaborative consumption business models has seen companies like Uber™ (transport) and Air BnB™ (accommodation) grow into multi-billion dollar companies. These types of companies allowing for the sharing of items or services through web portals or mobile apps. However, these previous companies have never successfully applied the sharing concept to the designer clothing industry, neither has any previous business model that enabled a direct peer to peer sharing of designer clothing rentals such as the system or process described herein, and neither have they solved the inherent problems specific to an efficient designer clothing sharing system.

The first preferred embodiment is designed to deliver a rental auction based system or process wherein borrowers compete to rent designer clothing from lenders. The advantage is that borrowers often would like to rent designer clothing for special events and these special events occur at fixed times. Previous systems and processes that rely on subscription or fixed price based business models are not as efficient, as these models do not take into account the true market forces of supply and demand.

Typically, supply of designer clothing is limited and therefore the price of the designer clothing fluctuates with the force of demand. The force of demand, in the case of designer clothing, is generally determined by the need for designer clothing at special events. For example, if a special gala event is being held in a city in a particular night, many borrowers will require designer clothing for the event and they will all be competing for similar designer clothing items at the same time. This in turn will force the price to increase in accordance with demand pressure, and previous designer clothing distribution systems and processes are not able to address this market inefficiency.

Alternatively, the number of events in a location is typically lower during the mid-week periods and therefore, you would normally expect the price of renting designer clothes to fall during these times of lower customer demand, and previous designer clothing distribution systems and processes are not able to address this market inefficiency.

The market force exhibited by supply side forces is relatively inelastic as the supply of designer clothing items is not expected to significantly change in short term analysis.

The first preferred embodiment employs a collaborative consumption business model, may be based a purely online operating through an internet portal or website. The system or process is preferably event based (one-off hire each time) business model, and it is the only provider or lender that has introduced an online auction, specifically customised and built for designer clothing rental.

The embodied process or system may allow borrowers to rent out their designer clothes directly from a lender. Users can be: a lender; a borrower; or both. Preferably, the process or system works on a transactional basis and requests a first payment on behalf of the lender from the borrower once the bidding for the item of designer clothing has been finalised. The system or process then makes a second payment to the lender or acknowledges it has facilitated a direct secure payment between the borrower and lender. The payment by the borrower, is facilitated by the system or process, to cover delivery costs, any insurance costs and commissions of the system/process operator.

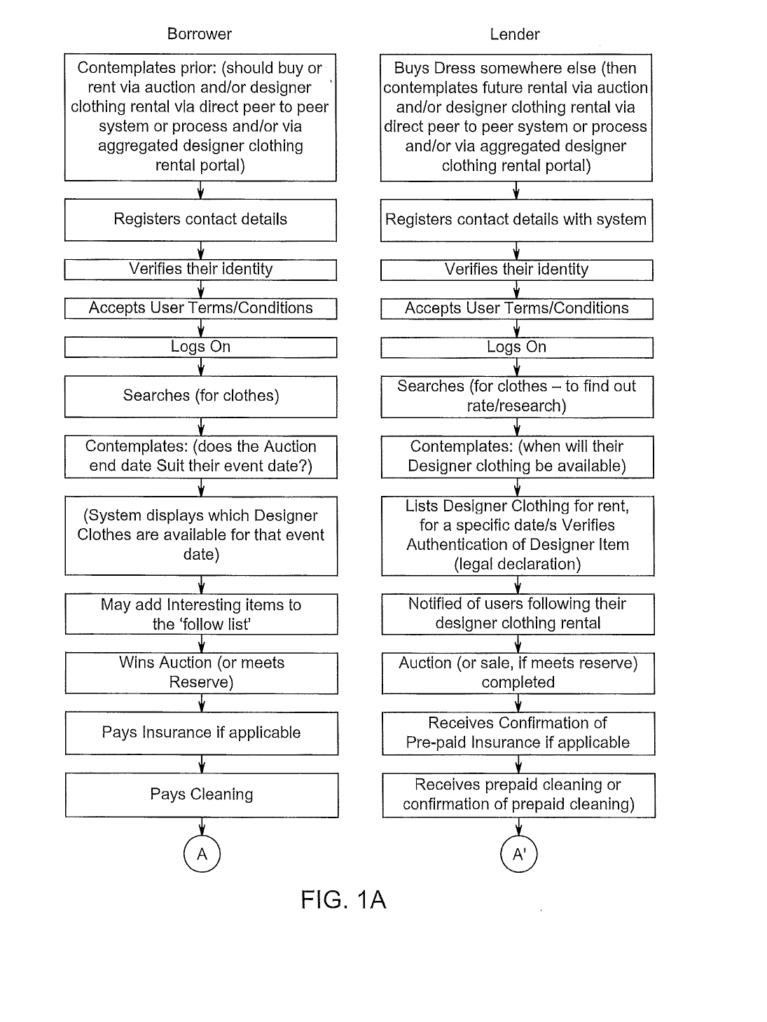

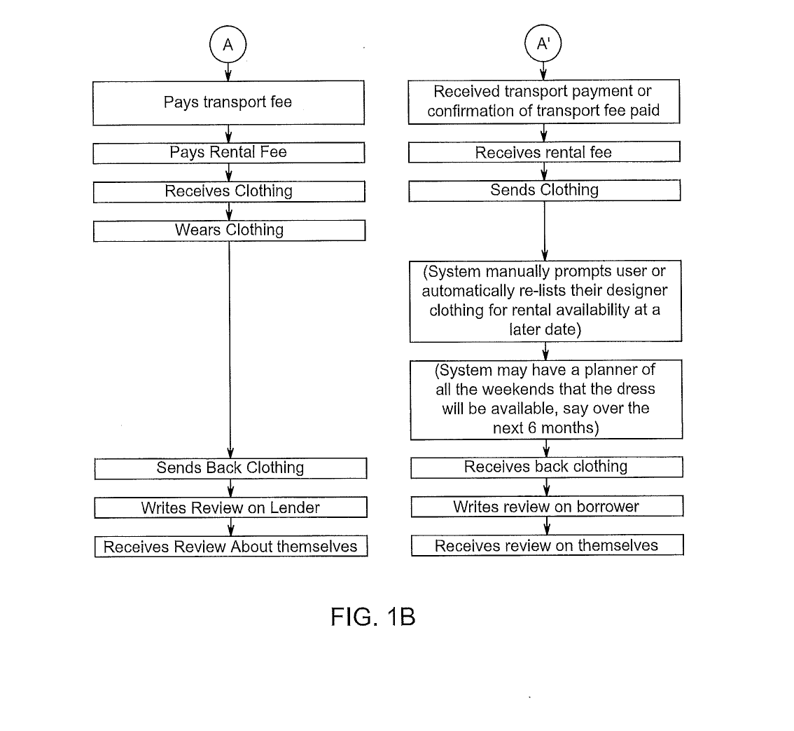

The system and process is described in detail in FIGS. 1A & 1 B, wherein a flowchart has been provided to identify some of the various steps and stages involved within the first preferred embodiment.

The flowchart of FIGS. 1A & 1B is divided into two main areas of processing which occur side by side or simultaneously throughout the preferred system or process. Initially, the lender and borrower visit a website or internet portal running software that incorporates the first preferred embodied system or process.

The lender and borrower both agree with the system terms and conditions and enter basic contact information about themselves including but not limited to: name, address, mailing address, email address, phone numbers, credit card details, payment details, country or jurisdiction locating information. The respective information from the lender or borrower is stored by the system in a respective lender or borrower profile.

The lender profile also stores information regarding lists of designer clothing that is available for renting and the respective time period availability information for each piece or article of designer clothing. The lender profile may also store example photos of the designer clothing and brief descriptions including designer information, quality, and condition of clothing.

The borrower profile stores information primarily about the borrower and their contact details. It may also store additional information about the borrower's sizing or clothing preferences. These clothing preferences may include information such as: I prefer male or female clothing, and I like/dislike hats/shoes etc.

Borrower's may utilise the system or process to search the lender's profile for list of appropriate designer clothing for which they may wish to borrow. Specifically, the borrower may search the databases and profiles based on fields including: type of clothing, designer, cost, time/date availability, location.

Further improvements to the process and system may include allowing individual designers of designer clothing to act or become direct lenders of their unique designed clothing. This may give an additional advantage of cross promoting designers and designer clothing directly to interested parties as the lists of borrowers.

Preferably, the system includes basic website security and protects the privacy of users. Exact details of the other users are only visible once the transaction has been completed. Prior to completion of the transaction, users may only see basic information of other third party users. Specifically, protected information may include real names, real addresses and real emails of the users.

Specifically, the system described in the flowchart, accepts registrations from lenders or borrowers. The lenders and borrowers are verified by the system, then they individually accept the terms and conditions associated with the system. Once, the borrower has chosen a preferred item of designer clothing to rent, the borrower may place a bid for the item of designer clothing and if applicable, by a specific time. Other borrowers may simultaneously bid on the same item wherein the each subsequent bid must be higher than the earlier bid. Preferably, the system monitors real time availability of the items or pieces of designer clothing to ensure their availability for bookings and events. The time availability may be displayed in a graphical interface which is overlayed with a calendar showing the available and already booked/rented days/times/

Preferably, the system may close bidding to the online auction at some minimum predetermined time. This predetermined time is typically the minimum time needed to deliver the items to the borrower (e.g. 2-3 days or 2-3 months) prior to the use or rental date so that the borrower can use the item of designer clothing at a function or event. However other minimum time frames may be adjusted by the lender. The system evaluates which borrower has made the highest bid prior to the closing time or date of the online auction for the item of designer clothing. Typically, the lender may be required to agree to deliver the items of design clothing by the nominated delivery date or forfeit the monetary consideration.

The preferred system may then require the successful winning borrower to make a first payment. The preferred first payment includes: the fees payable to the lender, fees for insurance of the item if it is lost or damaged, cleaning costs, delivery or transport fees and system commission fees. The first payment may be a direct payment between borrower and lender, facilitated by system, or if it is a payment to the system, then the system pays a second payment to the lender and this second payment typically only includes fees payable to the lender.

Delivery fees are paid or facilitated by the system from the money supplied by the borrower. The delivery fees cover: a) delivery to the borrower; and b) return delivery fee of returning the item to lender. Preferably, the system produces pre-printed delivery packages or labels suitable for the initial delivery to the borrower and return trip back to the lender. Preferably, these packages or labels are arranged so as to expose the first delivery address of the borrower and then easily be modified to expose a second delivery address of the lender. The delivery packages may be reused and the system may preferably organise for courier deliveries and pickups to the specified addresses of the respective parties. The pre-printed labels on the packages reduce the likelihood that the packages are incorrectly delivered to the wrong address. The payments may be also handled by a third party payment technology such as Paypal™ or others however the processing of the payment is facilitated by the embodied system and the system will handle the necessary servers negotiations with the Paypal™ or others technology/system.

Preferably, the system may produce and electronically deliver a custom three dimensional (3D) printing file to the Lender and/or Borrower, which enables the Lender and/or Borrower to print a custom 3D printed package and/or 3D printed label using a 3D printer connected to the computer that Lender and/or Borrower is using and that this 3D printing facility is specific for efficiently facilitating the rental of designer clothing, directly between lender and borrower. Preferably, the 3D printing file includes electronic instructions or code adapted to allow a 3D printer to print 3D objects including labels and packages for use with the system.

Preferably, the cleaning costs are covered in a payment to the lender and the lender has agreed to fixed or minimum cleaning costs as part of the aforementioned terms and conditions of the system. Preferably, the lender is responsible for cleaning the items once they are returned after the transaction is complete.

Alternately, the borrower may be required to clean the items prior to their return to the lender. The operation of the responsibility of cleaning is generally agreed between the lender and borrower prior to activating the transaction.

The preferred process or system is described in detail in FIGS. 1A and 1B. The process demonstrates some preferred steps operating in tandem or simultaneously between the lender and/or borrower. Generally, the process includes: a user verification and security check wherein the user being the lender or borrower verify their identity to the system. The lender may make a listing on the system for each item of designer clothing. Other users are notified of the listing by the lender, this notification may take the form of an email notification or a general untargeted advertisement on the system.

The item of design clothing listed by the lender is available to auction. Preferably, the lender may set a predetermined reserve or minimum starting price that they are willing to accept for the transaction. Alternately, the lender may opt for a fixed price auction wherein the item of designer clothing if offered at fixed price or static price subject to availability.

Prospective borrowers compete to bid on the auction for the rental of item of design clothing. If the reserve price is met, the highest bidder from the borrowers is selected as the winner of the auction. The winning borrower is then contacted by the lender or system to process payments.

This process and system of the first preferred embodiment of the present invention includes all or some of the steps described in the accompanying figures. References to “herself” or “himself” are intended to mean a non-gender specific person or self.

Preferably, the system or process may also include an item verification step wherein each particular listed item of designer clothing is authenticated as being an original item from that the designated designer. This verification may take place as a legal declaration or a verification check by system operator confirming that the item is genuine.

Another improvement may to allow for advertising or preferential recommendations to be supplied to potential borrowers, wherein the system automatically alerts or messages potential borrowers to the availability of special designer clothing or designer clothing of a preferred size or type that matches the borrower profile information.

Although FIG. 1b makes specific reference to “weekends” other dates and times may be flexibly handled and managed by the system.

Preferably, the system may include optional steps whereby the lender or borrower performance throughout any given transaction is able to be reviewed and commented on and the reviews and comments are available to general users of the system. The reviews may take the form of star ratings out of a maximum of 5 stars or may be comment driven.

Preferably, the system is adapted to facilitate the delivery of the items or pieces of designer clothing direct to the physical location which is predetermined by the borrower. The borrower may elect a predetermined delivery address rather than the prior art system that rely on dropoff or pickup points or intervention by a central location (in addition to transportation). Preferably, the present system does not include pickup or dropoff points or physical intervention by a central location (except transportation) as such physical intervention unnecessarily increases the cost of each transaction, it reduces the usability and efficiency of the system, and it adversely places an undue burden and great inconvenience on the borrower to arrange for the items or pieces of designer clothing to be gathered from the pickup or dropoff location or delivery to/from the central location.

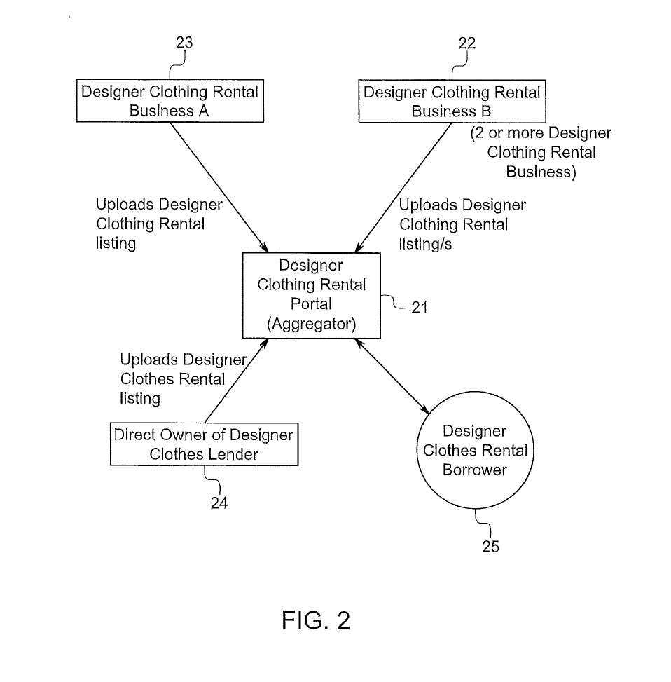

FIG. 2 depicts an expanded system or process architecture wherein the diagram shows the above described process or system of the first preferred embodiment illustrated with reference to FIGS. 1a and 1b being run or managed by a web portal. The web portal is preferably an aggregator 21 which interacts and manages the processes of the first preferred embodiment using code adapted to run on internet browser via the internet. The aggregator 21 is preferably an internet web portal operated by software operating on an internet server.

The aggregator 21 administrates the process and transaction and interacts with various user and user types. In FIG. 2, the aggregator 21 is interacting with three different listing groups or types of lenders and these preferably are: Designer Clothing Rental Business A 23, Designer Clothing Rental Business B 22, and a direct owner of designer clothes or controller of the items 24. All of these types or groups of lenders may simultaneously list provide listings of items of designer clothes to be advertised on the aggregator 21 for rent. (Designer Clothing Rental Business A and Designer Clothing Rental business B are the same type of designer clothing rental businesses and are listed as A and B to represent multiple users of that same type. There may be also multiple users of 24 and 25)

Preferably, the aggregator may also automatically data-mine the lists of designer clothing items directly from the lender group, wherein the lender is a business or a owner of designer clothing. Specifically, the aggregator 21 may visit a website or a server address on the internet of a lender group and detect various items of designer clothing to be listed. The aggregator may detect certain fields of data to be mined from the lender's website including: item details, availability details, costs, condition of item, item description and photos of the item. The aggregator may then replicate the listing information detected and identified from the lender's website and may republished the information with the verification and consent of the lender group, if consent is required.

The borrowers 25 interact with the aggregator 21 by browsing the rental designer clothing listings shown on the displays of the aggregator 21 and the borrowers 25 may then interact with the aggregator 21 to process the transactions by a similar process as described in reference to the first preferred embodiment and FIGS. 1a and 1b.

Preferably, the system or process shown in FIG. 2 may be adapted to different composition mixes of lenders whereby: the system includes only direct designer clothes owner—lenders 24 and does not include rental businesses A or B.

Previously, there has been no designer clothes sharing system which incorporates ‘Peer to Peer Sharing’ with the existing purchasing process of designer clothing buyers and designer clothing retailers. It will be appreciated that in the following embodiments the term designer clothing sharing system may include a process.

In a further embodiment, the designer clothing sharing system may be adapted to enable a designer clothing retailer to upload or electronically send designer clothing data to the designer clothing sharing system. The data may include at least one of a set of; images, descriptions, purchaser contact details, or any other predetermined data set desired by the user of the designer clothing sharing system. It will be appreciated that the data may be uploaded or sent prior to, or after selling a designer clothing item or designer accessory, either online or offline. The uploaded or sent data may be sent directly to the publicity viewable sharing portal or to the backend of the designer clothing sharing system in communication with the sharing portal. In this specification, the designer clothing item may mean an item of designer clothing or a designer accessory, such as an fashion item of jewellery, a belt, a hat, shoes, watches (including smart watches), handbags, bags, gloves, ties, sunglasses or any other wearable accessory. The term ‘sharing portal’ in this embodiment means a portal in which sharing data may be accessed or may be interchangeably used with the term ‘web portal’. The term ‘communication with the sharing portal’ may be, for example, via an Application Program Interface (API), but is not limited to an API, and may be any other type of electronic or automated or any other type of communication.

By including selected aspects of the designer clothes sales process with selected aspects of the designer clothing sharing system may produce a number of significant advantages. Utilising the designer clothes sales process and the designer clothes sharing system may cooperatively create additional market efficiencies and additionally improve the reliability of the distribution method for designer clothing and the sharing of designer clothing as well as maximising the profit of the borrower.

In this specification the term “designer clothing retailer” means a retail outlet, either online or in a physical retail store, or an individual who possesses an item of designer clothing, who wishes to share or borrow at least one item of designer clothing or a designer accessory to the general public (e.g. not wholesale). Further, the term ‘sharing’ is used interchangeably with borrowing but may also mean an item of clothing which free for a lender to use. The ‘Sharing Economy’ of designer clothing may also be referred to as the ‘On Demand Economy’ of designer clothing.

Previously, in the event that a designer clothing retailer was in the process of selling an item of designer clothing, either online or otherwise, or was in the process of sharing an item of designer clothing, there was no method for the retailer to view the potential future sharing economy value of the sold or shared item of clothing. Further, there was also no automated method for calculating the potential future sharing economy value of a sold or shared item of clothing or designs similar thereto. There are a number of significant advantages associated with calculation of the sharing economy value. ‘Sharing Economy Value’ may also be referred to as ‘Peer to Peer Rental Value’ or ‘On Demand Value’.

Calculating a sharing economy value for an item of clothing may increase the overall profits of the designer clothing retailer. For example, but not limited to, if an item of clothing was to be listed as $X, the retailer could maximise profits by using a calculated sharing economy value $Y instead, which may be calculated from at least one data set associated with the item of designer clothing. Using the sharing economy value $Y during the sales process may allow a retailer to maximise the sales price and/or to increase the number of units sold of that designer clothing item. The purchaser may also see the additional benefit of the sharing economy value ($Y−$X) and can use it to maximise their potential future sales or rentals of the item of designer clothing. The data used to derive $Y may be from similar items of designer clothing or accessories that have been rented in the past, to predict the future sharing economy value or an estimated range of that value.

In another embodiment, the sharing economy value may determine whether an item of designer clothing should be sold or have the price decreased or increased before being sold. This sharing economy value may be based on the frequency in which the item of designer clothing is successfully rented in the past, or the frequency in which similar items of clothing are successfully rented, or being shared or being used ‘on demand’. This sharing economy value may be an indicator of fashion trends changing and usage longevity of designer clothing items. calculating this sharing economy value may maximise the potential sales of the retailer, as at least one of the retailer or purchaser becomes aware of the designer clothing item's potential ‘sharing economy value’ during the sales process, a benefit they previously were not advised of, as part of the sales process.

Also the ‘sharing economy value’ is a value assigned to an item of designer clothing which may be calculated based on data assigned to the item of designer clothing, or may be based on data from other items of clothing similar to that of the item of designer clothing. The sharing economy value may be calculated by the designer clothing sharing system and optionally be displayed on a display device to a user. The sharing economy value may be one of a numerical scale value, a monetary value or otherwise any descriptor that may factor a potential future value of the item. In one example, the item of designer clothing may be assigned a word value or similar qualitative value such as: very good, good, average, poor or very poor. This sharing economy value may subsequently be used to indicate the likelihood of future sharing of the item of designer clothing or otherwise be used to factor a predicted sharing economy value previously assigned to the item of clothing in which the word values are assigned a weighting factor.

For example, if an item of clothing was assigned an original sharing economy value of $100 and the item of clothing has a “good” value with a factor of 0.9 the new value of the clothing would be $100×0.9=$90. However, other factors or predetermined values may be used to calculate the sharing economy value. It will be appreciated that a user of the designer clothing sharing system may be a designer, a designer clothing retailer, a designer clothing sharer or the like. It will be appreciated that the calculated sharing economy value may be a comparison of at least one data set value assigned to the item of clothing and at least one predetermined value stored on a storage means by the designer clothing sharing system. The storage means may be, for example, a server, an internet server or cloud based storage means, or any other suitable means for storing data. The designer clothing sharing system and process for calculating the sharing economy value is not limited to the above examples and other factors, condition status, predetermined values or data sets may be used to calculate the sharing economy value. The sharing economy value may be stored on the designer clothing sharing system or process for at least one of; further calculations, cross referencing to other items of designer clothing, used as item history, or otherwise stored on the storage means in communication with the designer clothing sharing system or process.

The designer clothing sharing system allows the designer clothing retailer to enter at least one descriptor of an item of designer clothing, either manually by entering in the designer clothing sharing system an identifier of the item of clothing, or electronically entered into the designer clothing sharing system by known scanning methods of a retail barcode or other identifier. The designer clothing sharing system subsequently assesses at least one desired data set related to the designer clothing, such as rental data or similar clothing data or any other predefined data set. The designer clothing sharing system may be configured to display the assessed data on a display device. The display device may display the sharing economy value which may show at least one of; a potential future transactional ‘rental estimate’, a ‘sharing economy estimate’, ‘a peer to peer rental estimate’, an ‘on demand estimate’ a rental history, and a sharing history of that item of designer clothing, or items of designer clothing similar to that of the item of designer clothing which has been entered into the designer clothing sharing system. Optionally, recommendations may be displayed on the display screen. These recommendations may be related to the sharing economy value and may suggest, for example, a recommended ‘sharing’ or ‘rental’ or ‘on demand’ price for the item of designer clothing, a recommended selling price, similar items already listed for sharing or renting, a list of borrowers or lenders seeking the item of designer clothing, or any other recommendation related to the item of designer clothing.

In a further embodiment, the designer clothing sharing system may automatically update the sharing economy values of the items of clothing entered into and stored on a storage means associated with the designer clothing sharing system. The designer clothing sharing system may then actively and/or adaptively display information to a user to recommend reserve prices or sale prices or sharing prices or rental prices or on demand prices, for an item of designer clothing. This may assist a user to adjust prices of inventory to better suit the demand of the lenders, and overall increase profits for retailers, lenders or any other associated user.

In yet another embodiment, the designer clothing sharing system may be adapted to enable a designer clothing sharer to upload or electronically send designer clothing data to the designer clothing sharing system or process. The data may include at least one of; images, descriptions, or purchaser contact details, or any other predetermined data set desired by the user into the designer clothing sharing system. It will be appreciated that the data may be uploaded or sent prior to selling, or after selling, either online or offline, a designer clothing item or accessory. The uploaded or sent data may be sent directly to the publicly viewable sharing portal or to the backend of the designer clothing sharing system in communication with the sharing portal. Optionally, the designer clothing sharing system may allow a retailer, lender or borrower of the designer clothing sharing system to choose whether or not to upload or send data to the sharing portal. The ‘communication with the sharing portal’ may include within its meaning, but is not limited to, an API, or any other type of electronic or automated or other type of communication.

By including the designer clothes sales process with the designer clothing sharing system, a significant number of advantages may be achieved. Particularly, utilising the sales process and the designer clothes sharing system may create market efficiencies and improve the reliability of the distribution method for designer clothing and the sharing of designer clothing as well as maximising profits of the designer clothes retailer and the designer clothes purchaser and the designer clothes lender overall.

In this specification the term “designer clothing sharers” means an individual who is a retailer or a purchaser or potential purchaser of a designer clothing item, or is a lender or potential lender of a designer clothing item, or is a borrower or potential borrower of a designer clothing item, or possesses an item of designer clothing under their management as an individual or as a business, who interacts with at least one item of designer clothing or a designer accessory with the designer clothing sharing system of the present disclosure. It will be appreciated that the designer clothing sharers may be a one off sharer or a return sharer of designer clothing. The designer clothing sharers may have an account associated with the designer clothing sharing system or process to facilitate sharing of designer clothing. A designer clothes sharer may be an at least one of; an individual, a business or retailer, using the designer clothing sharing system to gain exposure or to increase brand recognition through online or mobile or any other type of automated or electronic means.

Previously, in the event that a designer clothing retailer was in the process of selling an item of designer clothing, either online or otherwise, there was no automated method for the retailer to view the potential future ‘sharing economy value’ of the sold or shared item of clothing. Further, there was also no automated method for calculating the potential future sharing economy value of a sold or shared item or clothing or designs similar thereto.

The designer clothing sharing system allows the designer clothing sharer to enter an item of designer clothing's description, either manually by entering in the designer clothing sharing system an identifier of the item of clothing or by known scanning methods of the retail barcode or identifier or by API or by any other automated or electronic means. The designer clothing sharing system subsequently assesses at least one desired data set related to the designer clothing, such as rental data or peer to peer sharing data or any other predefined data set. The designer clothing sharing system may be configured to display the assessed data on a display which may show at least one of; a potential future transactional ‘rental estimate’, a ‘sharing economy estimate’, a rental history, and a sharing history of that item of designer clothing, or items of designer clothing similar to that of the item of designer clothing which has been entered into the designer clothing sharing system, similar to that of a designer clothing retailer.

In yet a further embodiment, the designer clothing sharing system or process enables a designer to upload or electronically send designer clothing data to the designer clothing sharing system. The data may include one or more data sets selected from the following list; images, descriptions, or purchaser contact details, or any other predetermined data set desired by the user into the designer clothing sharing system. The data gathered may be aggregated with at least one data set associated with the item of designer clothing and may be used to calculate the sharing economy value of the item of designer clothing. It will be appreciated that the data may be uploaded or sent prior to, or after selling a designer clothing item or accessory, either online or offline. The uploaded or sent data may be sent directly to the publicity viewable sharing portal or to the backend of the designer clothing sharing system in communication with the sharing portal, similar to that of the designer clothing retailer.

By including the designer clothes sales process with the designer clothing sharing system a number may result with a number of significant advantages. Particularly, utilising the sales process and the designer clothes sharing system may create market efficiencies and may improve the reliability of the distribution method for designer clothing and the sharing of designer clothing.

Previously, in the event that a designer clothing retailer was in the process of selling an item of designer clothing, either online or otherwise, or was in the process of sharing an item of designer clothing, there was no method for the retailer to view the potential future ‘sharing economy value’ of the sold or shared item of clothing. Further, there was also no automated method for calculating the potential future sharing economy value of a sold or shared item or clothing or designs similar thereto.

The designer clothing sharing system allows the designer to enter at least one descriptor of an item of designer clothing, either manually by entering in the designer clothing sharing system an identifier of the item of clothing, or electronically entered into the designer clothing sharing system by known scanning methods of a retail barcode or other identifier or by API or any other type of electronic or automated means. The designer clothing sharing system subsequently assesses at least one desired data set related to the designer clothing, such as rental data or similar clothing data or any other predefined data set. The designer clothing sharing system may be configured to display the assessed data on a display which may show at least one of; a potential future transactional ‘rental estimate’, a ‘sharing economy estimate’, a rental history, and a sharing history of that item of designer clothing, or items of designer clothing similar to that of the item of designer clothing which has been entered into the designer clothing sharing system.

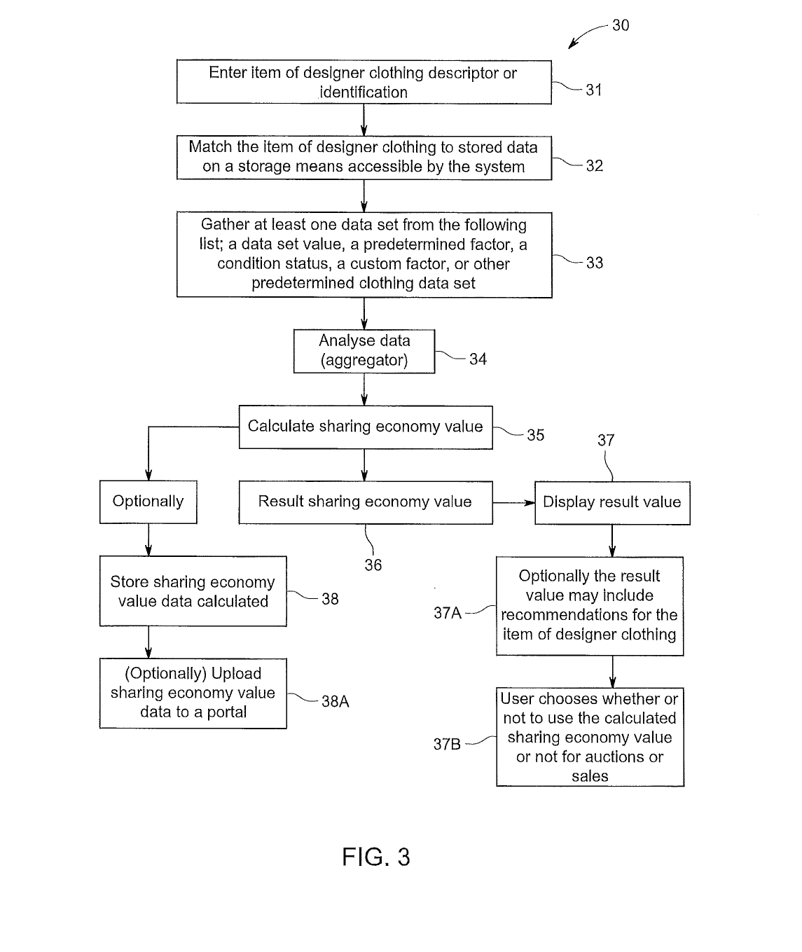

FIG. 3 depicts a flowchart 30 of the designer clothing sharing system. The FIG. 3 shows an embodiment of the above described designer clothing sharing system in which an item of designer clothing descriptor or identification is entered into the designer clothing sharing system 31. The system matches the item of designer clothing with the data of the item of designer clothing stored on a storage means 32 accessible by the designer clothing system. The designer clothing sharing system may then gather at least one further data set 33 from the following list; a data set value, a predetermined factor, a condition status, a custom factor, or other predetermined clothing data set. The item of clothing data and the gathered data may then be analysed or aggregated 34. The aggregated data may then be used to calculate a sharing economy value data 35 associated with the item of designer clothing. The result sharing economy value 36 is then produced and may be displayed 37 on a display device. The displayed sharing economy value may also display a number of recommendations for the item of designer clothing 37A based on the sharing economy value, such as a recommended auction price, selling price. These recommendations may then be used for an auction or for selling an item of designer clothing 37B. Optionally, the calculated sharing economy value data may be stored on a storage means associated with the designer sharing clothing system 38. The stored sharing economy value data may also be uploaded to a web portal 38A and stored on a web server.

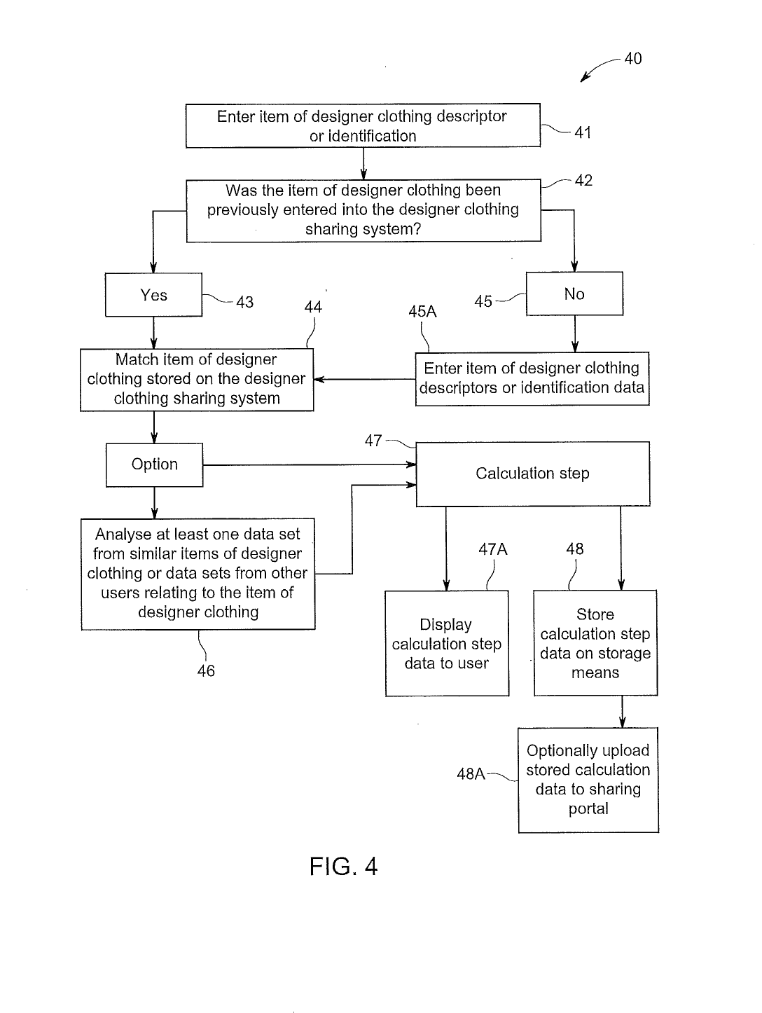

FIG. 4 depicts another embodiment of the designer clothing sharing system 40. FIG. 4 shows entering an item of designer clothing descriptor or identification into the designer clothing sharing system 41. The system checks whether the item of designer clothing has previously been entered into the system 42. If the item of designer clothing has been entered into the designer clothing sharing system 43 the item of designer clothing is matched to the stored data on the designer clothing sharing system 44. If the item has not been entered into the designer clothing sharing system 45 the item of designer clothing descriptors or identification data is entered and stored into the designer clothing sharing system 45A and the designer clothing sharing system is then matched to the stored data on the designer clothing sharing system, similar to that if the item of designer clothing had been entered into the system. After matching, the system may optionally analyse at least one data set from the following list 46; data from similar designer clothes, data sets from other users relating to the item of designer clothing, and stored data sets related to the item of designer clothing. At least one data set for the item of designer clothing may then be calculated at a calculation step 47 with reference to the matched data and/or any other optional data sets. The data set calculated at step 47 may include a sharing economy value, a data set from similar items of designer clothing (such as images or descriptions), previously displayed data from auctions or sales for an item of designer clothing, or any other desired data set. The data set may then be displayed to the user on a display device 47A. In this embodiment the calculated data set may be stored on a storage means 48 associated with the designer clothing sharing system. Optionally, the stored sharing economy value data may be uploaded to a web portal 48A and stored on a web server.

In yet another embodiment, lenders or borrowers may associate their user name or details associated with the designer clothing sharing system with an item of clothing. This association may issue a notification, such as a text message, sound notification, email, a push notification, or any other type of notification, to the lender or borrower when a desired item of designer clothing is up for sale or for rent. This allows a borrower or lender to track or otherwise monitor a desired item of designer clothing. Associating a lender or a borrower with a designer clothing item, and may place the lender or borrower on a short list for the borrower or lender to transact with each other or to indicate demand for that item of designer clothing.

It will be appreciated that the terms ‘designer clothing retailer’, ‘designer clothing sharer’ and ‘designer’ may be interchanged. Further, at least one of; a designer clothing retailer, a designer clothing sharer and a designer may be a user of the designer clothing sharing system. Calculated sharing economy values or other data sets calculated or analysed by the designer clothing sharing system may optionally be stored on a storage means for future use by the user of the designer clothing sharing system or a user of the sharing portal. The term ‘auction’ throughout this specification may also be a fixed price or single price auction wherein when a person places a ‘bid’ the auction is successfully completed and the item of designer clothing is rented or otherwise sold.

In at least one embodiment, an auction may mean a fixed price or purchase price that may allow a user of the system to buy or rent an item of designer clothing. In another embodiment, if a predetermined threshold is exceeded the item of designer clothing may be rented or purchased.

In some embodiments, bidding for an item of designer clothing may also include committing to buy or rent an item of designer clothing at a fixed price. The term auction may also mean buying or renting an item of designer clothing at a fixed price.

In previous prior art devices, systems and processes, the pick-up points for items of designer clothing delivered through similar system may have been dictated or predetermined by the lender or system. This may essentially mean that the pick-up points were previously convenient for only lenders or system operators but not for the borrower. The present embodiments preferably deliver the items of designer clothing direct to borrower without the need for pick-up or drop-off points. The transportation of the items of the designer clothing is preferably facilitated directly between the lender's chosen address and the borrower's chosen address which may remove the need for central storage or processing hubs which system operators may have previously run or managed to store the items prior to delivery and pickup.

Previously, there has not been a system of connecting a peer to peer network of potential managers of rental items of designer clothing that may each be limited by inventory constraints. Additionally, a network of peer to peer designer clothing owners may be limited by constraints, such as time or management difficulties, in the designer clothing sharing industry. At least one of the above embodiments may alleviate the inventory purchasing constraints of a peer to peer rental lender, with peer to peer designer clothing borrowers that may be limited by effort and time management constraints. The present embodiment enables an individual lender the option to assign an item of designer clothing, to be managed by a rental business lender or any other lender (business or individual) that are available to manage designer clothes owned by another party or parties. The rental business lender may then receive a commission for managing the at least one item of designer clothing on behalf of the designer clothing owner. This may enable the designer clothes sharing and rental industry to operate in a more efficient manner.

In at least one embodiment, a renter or lender may require uploading or submitting a form of suitable identification (ID). Suitable ID may comprise at least one of a name and a date of birth. A form of suitable ID may be at least one of; a social security number, a tax file number, a government issue ID, government ID, or other type of ID or ID Data or Personal ID or Business ID Data, a driver license, a utility bill, a letter, a passport, or any other form of predetermined identification. The system may be adapted to electronically validate at least one form of suitable ID. The standard of ID verification may be compliant with ‘Know Your Customer’ regulation or anti money laundering regulations.

Optionally, the term ‘auction’ may mean at least one of a fixed price, a make an offer threshold price, a sale price or a bidding price which terminates at a predetermined time or dynamic time.

In another embodiment, a social media profile or account profile of at least one of the renter and the lender may be associated with the system of the present disclosure. More particularly, the system of the present invention may associate at least one data set from at least one of a sale history, a transaction history, a reputational history, review data, pending or previous transaction data or any other predetermined data set associated with at least one of a social media account, a user account or a user history, such data from as eBay™, an Etsy™, Google™ AdWords or Facebook™ for example. This provides the advantage of a previously built reputation to be established on the new website and may assist a renter or borrower to gain a sales advantage if they have already established an online account elsewhere.

Further, if the system is configured to allow at least one social media account to be associated with a peer to peer designer account, the at least one social media account may be used by the system to promote or otherwise provide ads to at least one of the social media accounts. For example, a user of the system with an associated social media account may tag at least one of friends, contacts and connections who may be interested in renting or purchasing items of designer clothing. In addition, the system may also be adapted to allow a user to import or associate images or videos from a social media website or account for use with a designer clothing sale or auction. In a further embodiment, the system may allow at least one of clothing comments or designer clothing votes or likes from social media, or import designer clothing hashtags, or ‘event’ hashtags, or designer clothing descriptions, or designer clothing trends from social media.

In yet another embodiment of the present disclosure, the system may optionally be adapted to record, compile or distribute at least one data set. The data may be distributed to at least one user of the system or to a third party. The at least one data set may include real-time sharing data such as a running total of peer to peer designer clothes sharing ‘savings’ or an ongoing running total of designer clothes sharing ‘lending income’. At least one data set may optionally be reset either manually or at predetermined time intervals. This reset may be irrespective of an amount paid or a balance owing to a lender. At least one data set may also include dress data which is specific to peer to peer designer clothes sharing. Another peer to peer data set may include items such as the highest number of designer clothes peer to peer sharing between defined peer to peer geographic locations, the most popular peer to peer designer clothes sharing dresses, the most profitable peer to peer designer clothes sharing dresses, the most versatile peer to peer designer clothes sharing dresses.

In at least one further embodiment, the system of the present invention may allow delivery of an item of clothing by a drone or other autonomous delivery system.

In yet another embodiment, the system may carry out at least one of the following; identify a form or ID, associate a social media account, associate a service account, associate an image from social media, associate a review, associate an external user website, calculate a sharing economy value or rental value, associate an affiliate network or affiliate a software for the referral or peer to peer renters and/or lenders into the peer to peer designer clothes sharing system from external sources, integrate data from another collaborative or ‘sharing economy’ provider and integrate data from a third party insurance provider.

In this specification, a predetermined closing time may include any time interval or time period which may be assigned by a user or the system. Further, placing a bid may include at least one of buying a product at a fixed price, buying a product at an asking price or buying a product at an accepted offer price.

A fixed price may be entered by a lender or a lender may assign an auction to include at least one of a make an offer, a buy it for a fixed price or end after a predetermined time.

In a further embodiment, the lender may set a fixed price, or a fixed priced for winning bids, or may set a minimum starting value for the bids, or may be able to electronically accept or assess offers from renters or potential renters.

The system may also produce and electronically deliver a customised 2D or 3D printing file to the Lender or Borrower. Further, the preferred 2D (two dimensional) or 3D (three dimensional) printing file including electronic printer instructions to print a three dimensional package or label.

In yet another embodiment, the system may record a borrower profile associated with the borrower and a lender profile associated with the lender. Each lender's profile may include a list of designer clothing available to be rented; and a respective time availability information. After a borrower places accepts an asking price to rent at least one piece of designer clothing from the lender profile for a specified available time that matches the respective time availability information. The system may the close the list for the piece of designer clothing from borrowers and awards the rental of the piece of designer clothing to the borrower who accepted the asking price. The borrower may then facilitate a payment to the lender through the use of the system; and the lender arranges transport or pick up of the designer clothing to the borrower.

In at least one embodiment, a sharing portal may mean an online (including mobile or cloud) designer clothes sharing system or portal, displaying or aggregating a combination of rental business and individual owner listings collectively, or displaying or aggregating only multiple rental business' listings, or displaying or aggregating only listings of individual dress owners peer to peer or any other combination herein.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

The claims defining the invention are as follows:

1. A system for use in the rental of designer clothing from a lender to a borrower, wherein the system comprises the following steps:
a. recording a borrower profile associated with the borrower and a lender profile associated with the lender;
b. each lender's profile include a list of designer clothing available to be rented; and a respective time availability information;
c. at least one borrower places at least one bid to rent at least one piece of designer clothing from the lender profile for a specified available time that matches the respective time availability information;
d. at a predetermined closing time, the system closes bids from borrowers and awards the rental of the piece of designer clothing to the borrower who placed the highest bid at the closing time;
e. the borrower facilitates a payment to the lender through the use of the system; and
f. the lender delivers the designer clothing to the borrower.

2. The system according to claim 1, wherein the system comprises an additional step wherein the borrower pays a security deposit or authority to the value of piece of designer clothing.

3. The system according to any one of claims 1 to 2, wherein the borrower profile or lender profile includes additional review information about the respective borrower or lender independently submitted by third parties.

4. The system according to any one of claims 1 to 3, wherein the payment additionally includes: insurance costs, cleaning costs and delivery costs.

5. The system according to any one of claims 1 to 4, wherein the system is adapted to allow the borrower and lender to make comments about the performance of the opposed party which are recorded by the system in the respective lender or borrower profile.

6. The system according to any one of claims 1 to 5, wherein the borrower makes a first payment to the system and then the system makes a second payment to the lender.

7. The system according to any one of claims 1 to 6, wherein the lender sets a fixed price for the highest bid; or sets a minimum starting value for the bids.

8. The system according to any one of claims 1 to 7, wherein the system delivers at least of one piece of designer clothing to a predetermined address of the borrower without the need for a drop-off point.

9. The system according to any one of claims 1 to 8, wherein the system facilitates the transportation of the items directly between the lender and borrower without the need for central storage or processing hub; and wherein the items are cleaned by borrower or lender.

10. The system according to any one claims 1 to 9, wherein the system produces and electronically delivers a customised 3D printing file to the Lender or Borrower.

11. The system according to claim 10, wherein the 3D printing file including electronic printer instructions to print a three dimensional package or label.

12. A device for transacting the rental of items of designer clothing, wherein the device aggregates the lists of said items from multiple lenders and then displays said lists on a web portal interface for borrowers to interact with and browse; and
wherein the borrower wishes to rent said item, the device enables a transaction.

13. The device of claim 12, wherein the transaction includes an online auction.

14. The device of claim 13, wherein the aggregator uses a process to conduct the transaction and wherein the process includes the following steps:
a. recording a borrower profile associated with the borrower and a lender profile associated with the lender;
b. each lender's profile include a list of designer clothing available to be rented; and a respective time availability information;
c. at least one borrower places at least one bid to rent at least one piece of designer clothing from the lender profile for a specified available time that matches the respective time availability information;
d. at a predetermined closing time, the system closes bids from borrowers and awards the rental of the piece of designer clothing to the borrower who placed the highest bid at the closing time;
e. the borrower facilitates a payment to the lender through the use of the system; and
f. The lender delivers the designer clothing to the borrower.

15. The process according to claim 14, wherein the system comprises an additional step wherein the borrower pays a security deposit to the value of piece of designer clothing.

16. The process according to any one of claims 14 to 15, wherein the borrower profile or lender profile includes additional review information about the respective borrower or lender independently submitted by third parties.

17. The process according to any one of claims 14 to 116, wherein the payment additionally includes: insurance costs, cleaning costs and delivery costs.

18. The process according to any one of claims 14 to 17, wherein the system is adapted to allow the borrower and lender to make comments about the performance of the opposed party which are recorded by the system in the respective lender or borrower profile.

19. The process according to any one of claims 14 to 18, wherein the borrower makes a first payment to the system and then the system makes a second payment to the lender.

20. The process according to any one of claims 14 to 19, wherein the lender sets a fixed price for the highest bid; or sets a minimum starting value for the bids.

21. The process according to any one of claims 14 to 20, wherein the system delivers at least of one piece of designer clothing to a predetermined address of the borrower without the need for a drop-off point.

22. The process according to any one of claims 14 to 21, wherein the system facilitates the transportation of the items directly between the lender and borrower without the need for central storage or processing hub; and wherein the items are cleaned by borrower or lender.

23. A process for integrating a data set of an item of designer clothing, the process comprising;
entering at least one data set associated with the item of designer clothing into the system of claim 1;
the system in communication with a designer clothing sharing portal;
the designer clothing sharing portal configured to access at least one data set related to the item of designer clothing; and
wherein the at least one data set of the item of designer clothing and the at least one data set of the similar item of designer clothing are used to either calculate a sharing economy value, or assign a data set from the designer clothing sharing portal to the item of designer clothing.

24. The process of claim 23, wherein the sharing economy value is automatically determined and/or automatically displayed to at least one of a designer clothing retailer or a designer clothing sharer.

25. The process of claim 24, wherein the item of designer clothing can be managed by a network of designer clothing lenders such that when the item of designer clothing is managed a notification is sent to the lender who may be at least one of the designer clothing retailer or the designer clothing sharer.

26. A system for use in the rental of designer clothing from a lender to a borrower, wherein the system comprises the following steps:
a. recording a borrower profile associated with the borrower and a lender profile associated with the lender;
b. each lender's profile include a list of designer clothing available to be rented; and a respective time availability information;
c. a borrower places accepts an asking price to rent at least one piece of designer clothing from the lender profile for a specified available time that matches the respective time availability information;
d. the system closes the list for the piece of designer clothing from borrowers and awards the rental of the piece of designer clothing to the borrower who accepted the asking price;
e. the borrower facilitates a payment to the lender through the use of the system; and
f. the lender delivers the designer clothing to the borrower.
